(19) United States
(12) Patent Application Publication
(10) Pub. No.: US 2025/0146864 A1
(43) Pub. Date: May 8, 2025

(54) DYNAMIC COMPRESSION OF DISTRIBUTED SENSING DATA

(71) Applicant: NEC Laboratories America, Inc., Princeton, NJ (US)

(72) Inventors: Yuheng Chen, South Brunswick, NJ (US); Azita Nouri, Highland Park, NJ (US)

(21) Appl. No.: 18/934,714

(22) Filed: Nov. 1, 2024

Related U.S. Application Data
(60) Provisional application No. 63/595,819, filed on Nov. 3, 2023.

(51) Int. Cl. G01H 9/00

(52) U.S. Cl. CPC G01H 9/004

(57) ABSTRACT

Methods and systems for sensing include selecting sensing locations along an optical fiber. Reflections from an optical pulse are measured on the optical fiber to generate a line of raw sensing data. The line of raw sensing data is compressed in accordance with present network conditions to generate compressed sensing data. The compressed sensing data is transmitted to a client.

### RELATED APPLICATION INFORMATION

This application claims priority to U.S. Patent Application No. 63/595,819, filed on Nov. 3, 2023, incorporated herein by reference in its entirety.

### BACKGROUND

### Technical Field

The present invention relates to distributed acoustic sensing and, more particularly, to dynamic compression of sensing data.

### Description of the Related Art

Distributed fiber optic sensing can be used to monitor large-scale infrastructure in real-time. It provides long-range coverage compared to point sensors, but transmitting and processing the sensing data can be challenging.

### SUMMARY

A method for sensing includes selecting sensing locations along an optical fiber. Reflections from an optical pulse are measured on the optical fiber to generate a line of raw sensing data. The line of raw sensing data is compressed in accordance with present network conditions to generate compressed sensing data. The compressed sensing data is transmitted to a client.

A system for sensing includes a hardware processor and a memory that stores a computer program. When executed by the hardware processor, the computer program causes the hardware processor to select sensing locations along an optical fiber, to measure reflections from an optical pulse on the optical fiber to generate a line of raw sensing data, to compress the line of raw sensing data in accordance with present network conditions to generate compressed sensing data, and to transmit the compressed sensing data to a client.

A distributed fiber optic sensing system includes an optical fiber, a light source, a detector, a hardware processor, and a memory that stores a computer program. When executed by the hardware processor, the computer program causes the hardware processor to select sensing locations along the optical fiber, to transmit an optical pulse on the optical fiber using the light source, to measure reflections from an optical pulse on the optical fiber using the detector to generate a line of raw sensing data, to compress the line of raw sensing data in accordance with present network conditions to generate compressed sensing data, and to transmit the compressed sensing data to a client.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a distributed sensing system where waterfall information sensed from an optical fiber is compressed, in accordance with an embodiment of the present invention;

FIG. 2 is a block diagram of a distributed sensing system that uses an optical pulse on a fiber, in accordance with an embodiment of the present invention;

FIG. 3 is a block/flow diagram of a method for sensing and compressing information on an optical fiber, in accordance with an embodiment of the present invention;

FIG. 4 is a block/flow diagram of a method for using compressed waterfall information from an optical fiber to detect and correct anomalies, in accordance with an embodiment of the present invention;

FIG. 5 is a block diagram of a computing device that senses and compressed information from an optical fiber, in accordance with an embodiment of the present invention;

FIG. 6 is a diagram of an exemplary neural network architecture that can be used to implement a machine learning model that selects a data rate, in accordance with an embodiment of the present invention; and

FIG. 7 is a diagram of an exemplary deep neural network architecture that can be used to implement a machine learning model that selects a data rate, in accordance with an embodiment of the present invention.

### DETAILED DESCRIPTION OF PREFERRED EMBODIMENTS

Distributed fiber optic sensing makes use of acoustic sensing along the length of an optical fiber. Sensing data from the fiber can be measured as a spatial-temporal data stream, for example as a waterfall image where the intensity of a pixel represents signal strength at a location and at a time, the horizontal axis represents the location along the optical fiber, and the vertical axis represents temporal evolution. The data rate of this measurement scheme grows rapidly as the number of locations and/or sample frequency increase.

The sensing data may therefore be dynamically compressed for transmission. High-resolution waterfall images are efficiently transmitted in real-time between a server and a client, with large image sizes and potentially varying bandwidth. The compression may use GPU-accelerated compression to optimize the transmission of large images made up of waterfall information.

Machine learning may furthermore be used to select the most appropriate data rate between the sensing system and the server, based on the sensing data's features and real-time network conditions such as available bandwidth and latency.

The server reads in data from the sensing system in a raw wave and compresses the data using GPU-accelerated compression. The compressed data is transmitted to the client, where it can be used to respond rapidly to changing conditions within the monitored system. While the present data compression scheme is described with particular attention to applications in distributed fiber optic sensing, it should be understood that it may also be applied to other sensing platforms, such as RF networks, large-scale sensor networks, telecommunications, and medical imaging.

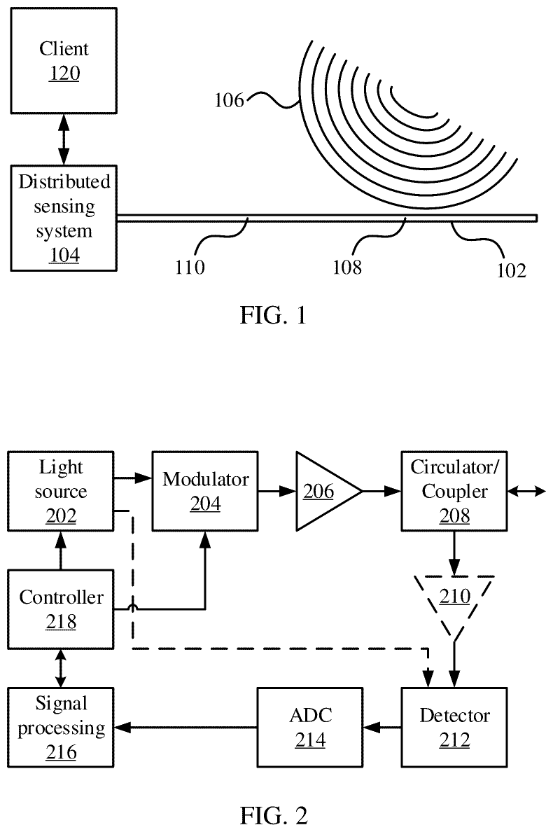

Referring now to FIG. 1, an exemplary acoustic sensor system is shown. A single optical fiber 102 is illustrated, with a distributed sensing system 104 at one end. An acoustic signal 106 is generated by a sound occurring in the vicinity of the fiber 102. As the acoustic signal 106 propagates through the surrounding medium (e.g., air), it impact the fiber 102 at different times along its length, due to the finite speed of sound through the medium. Thus, portions of the fiber 102 that are closer to the source of the acoustic signal 106 will be affected by the acoustic signal 106 sooner than portions of the fiber 102 that are farther away.

The fiber 102 may be any appropriate fiber-optic cable, such as a single-mode, few-mode, multimode, or other type of specialty cable. The fiber 102 acts as a continuous sensing element, with each section acting as a small sensor that can detect acoustic waves along its length. The fiber 102 can be wrapped in an elastic support material to increase the sensitivity and reduce the dimension, such as being wrapped around thin-wall hollow cylindrical transducers or being attached to the surface of an elastic cable.

Each point on the fiber 102 may be treated as if it were a separate microphone in an array. As an optical pulse from the distributed sensing system 104 travels along the length of the fiber 102, in this example from left to right, variations in the properties of the fiber 102 will cause reflections from the optical pulse to bounce back to the distributed sensing system 104. The point along the fiber 102 from which the reflection originates can be determined based on the speed of light within the fiber, measured from the time the optical pulse leaves the distributed sensing system 104 to the time the reflection is received.

In some cases, these reflections are signals that can be combined to form a beam of sensitivity that focuses on a specific direction relative to the fiber 102. This direction can be selected by changing the relative phases of the combined signals and by the position of the sensing location. The positions can be selected as above, by selecting reflections that arrive at the distributed sensing system 104 at a predetermined time based on their distance from the distributed sensing system 104 along the length of the fiber 102. For example, sensing locations 108 and 110 will generate different reflections that can be differentiated from one another based on the time of arrival of those reflections from the emission of a given optical pulse. The sensing locations 108 and 110 can be selected at any arbitrary points along the fiber 102.

In contrast to acoustic sensing that is performed using an array of discrete acoustic sensors, such as microphones, the distributed sensing system 104 can reconfigure the positions of the sensing locations simply by changing the time delay of the reflections that it measures. Thus sensing locations can be set to any arbitrary positions along the length of the fiber 102 simply by changing the measurements at the endpoint. Sensing using optical fiber has further advantages over the use of microphones, for example in its resistance to electromagnetic interference, long sensing range, high spatial resolution, and low maintenance needs. The measurements of the sensing data can thereby be made with arbitrary spatial resolution. For a long fiber 102, with many different points of measurement, the amount of data that is generated by a single optical pulse can be very large.

Although the present embodiments are described with respect to a single fiber 102, it should be understood that multiple such fibers can be connected to a distributed sensing system 104 with the use of, e.g., an optical switch or wave division multiplexing. The different reflected signals from the different fibers can then be processed independently to provide acoustic sensing in multiple locations.

The distributed sensing system 104 communicates with a client 120 to transmit measured sensing data to a display at the client 120. The client 120 may display a waterfall of sensing information and may transmit requests to the distributed sensing system 104 such as specifying a region of interest along the fiber 102.

Referring now to FIG. 2, an exemplary distributed sensing system is shown. This system makes use of scattering-based acoustic detection, but it should be understood that alternative systems are also contemplated, such as those which use forwarding. A light source 202 (e.g., a laser) generates an optical pulse. The optical pulse is modulated by modulator 204 and is amplified by optical amplifier 206 before being launched on the fiber 102 using circulator/coupler 208.

Reflected optical signals from the fiber 102 are directed by the circulator/coupler 208, optionally through an optical amplifier 210, to detector 212. The detector 212 may make use of a local oscillator signal from the light source 202 to aid in equalization. The detector 212 converts the received signal from the optical domain to the electrical domain, generating an analog electrical signal that is converted to digital by analog-to-digital converter (ADC) 214. Signal processing 216 receives the digital signal, which may include multiple reflections over time. The signal processing 216 may further provide feedback to a controller 218, which can set parameters for the light source 202 and the modulator 204 for future sensing.

The controller 218 may collect the sensing data into a waterfall image, with the horizontal axis representing different points along the length of the fiber 102 and with the vertical axis representing different points in time. With each new optical pulse, a new row is added to the waterfall image and may be transmitted to a client for display. The data rate of the sensing data thus depends on the number of points along the fiber 102 being measured and the frequency of optical pulses, which determines the temporal resolution.

For example, the controller 218 may include a GPU (Graphics Processing Unit) to accelerate compression of the waterfall data, thereby reducing latency in transmitting newly acquired sensing data and reducing the size of the data for transmission with limited bandwidth. The controller 218 may further adapt the data rate of the raw sensing data by changing the spatial resolution, thereby changing the number of pixels along the horizontal axis of the image. This dynamic data rate selection may be based on real-time network parameters such as bandwidth and latency and may be implemented using a machine learning model to adapt to a current network state.

The controller 218 may furthermore transmit the waterfall data in a striped fashion, where individual lines of the waterfall image are compressed and transmitted separately before being reassembled at the client. This allows the controller 218 to dynamically adapt to changing network conditions in the middle of a given waterfall. The client can furthermore request changes to the resolution, effectively zooming in on a particular region of the fiber 102, which the controller 218 implements by selecting appropriate sensing locations within a region of interest.

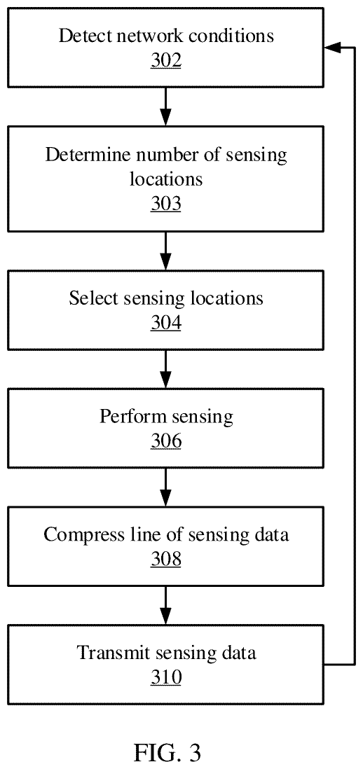

Referring now to FIG. 3, a method for transmitting distributed fiber optic sensing data is shown. Block 302 detects network conditions, for example by measuring available bandwidth and latency. Based on the network conditions, block 304 selects sensing locations across the fiber 102 in accordance with the network conditions. For example, the network conditions may indicate a certain available bandwidth, which may set a maximum data rate that can be transmitted. Block 303 may therefore determine a number of sensing locations that, after compression, will produce a data rate within the maximum data rate. Each sensing location may produce a predictable amount of compressed data, and so block 303 may determine a maximum number of sensing locations by dividing the maximum data rate by the data rate of an individual sensing location, less a margin of safety, or may use any other appropriate function.

Block 303 may employ a machine learning model to dynamically select the most appropriate data rate between the sensing system and the server. This selection may be based on both the features of the sensing data and real-time network conditions such as available bandwidth and latency. The machine learning models may optimize the balance between data fidelity and transmission efficiency. Various input features may be considered to output recommendations for data transmission parameters.

For example, the machine learning model may take certain network conditions and sensing data features as inputs. Network conditions may include available bandwidth, network latency, packet loss rate, jitter, and historical network performance metrics. Sensing data features may include signal variance, entropy, frequency content, detected anomalies or events, and statistical metrics.

Different machine learning models may be used depending on the situation. For scenarios that need rapid, real-time adjustments with clear interpretability, regression-based models such as gradient boosting regression and decision trees may be used. These models efficiently capture nonlinear relationships between inputs and outputs while providing fast inference times suitable for real-time applications.

Reinforcement learning (RL) models may be used in situations where the environment is highly dynamic and requires sequential decision-making. RL allows the system to learn optimal strategies for adjusting data transmission parameters by interacting with the environment and maximizing cumulative rewards related to performance metrics like throughput and latency.

The machine learning model generates optimized data rate settings. These settings may include a number of sensing parameters, compression parameters such as format, quality level, region-specific compression, and sampling rate adjustments. The model may be trained using supervised learning with a dataset made up of network conditions, sensing data features, and optimal data rate settings used in those scenarios. The model learns by minimizing a loss function that measures the discrepancy between the predicted and optimal settings.

For the reinforcement learning models, the system would interact with the environment, receiving rewards for actions that lead to an optimal balance in data transmission. Over time, the RL models would improve their policies to make better decisions under varying conditions.

By integrating these machine learning models into block 303, the system intelligently and autonomously selects data rate parameters that optimize performance. This approach enhances the overall effectiveness of distributed fiber optic sensing by ensuring that vital sensing information is transmitted efficiently, allowing for rapid detection and response to events or anomalies detected along the optical fiber.

Block 304 then selects the sensing locations, distributing the determined number across the fiber 102. In some cases these sensing locations may be distributed equidistantly across the fiber 102, while in other cases they may be located in regions of interest. For example, a region of interest may be selected by a user or client to define a particular length within the fiber 102, and the number of sensing locations may then be distributed within that length. In another example, the region of interest may be identified automatically responsive to the detection of an event or change in a region of the fiber 102. This can help the system to automatically improve the sensing resolution in an area with an evolving problem.

Block 306 performs sensing, sending an optical pulse along the fiber 102 and measuring the reflections. The sensing locations may be measured according to the timing of the reflections, as the speed of light within the fiber 102 is known, so that light will take a predictable amount of time to travel from the distributed sensing system 104, to the sensing location, and back. A single optical pulse may therefore be used to generate sensing information from multiple sensing locations, which may be rendered as a line of the sensing data waterfall.

Block 308 then compresses the line of sensing data, for example using GPU acceleration. For example, the line may be compressed as a JPEG (Joint Photographic Experts Group) image. In some cases, the machine learning model may adaptively select a compression method to respond to changes in network conditions. For example, a decrease in the available bandwidth may prompt block 308 to use a more lossy compression format, while an increase in the available bandwidth may prompt the use of a less lossy compression format. Different compression formats may also be applied in different regions, for example using a less lossy compression format to encode data from a portion of the fiber 102 with high activity and using a more lossy compression format to encode data from a portion with lower activity. Block 310 transmits the compressed line of sensing data to a client for review. The sensing data may be used by the client to identify problems with infrastructure or environmental changes, which can in turn be addressed by some correction action.

Processing may then return to block 302, where updated network conditions may be assessed and the data rate may be adjusted. In some cases blocks 302, 303, and 304 may not be performed at every iteration, such as when sensing is performed at a rate that is higher than an expected rate of change for the network conditions. In some cases a recalculation may be performed upon detecting significant changes in network conditions or sensing data features. This dynamic adjustment ensures efficient use of network resources while maintaining the necessary data quality for accurate sensing and analysis.

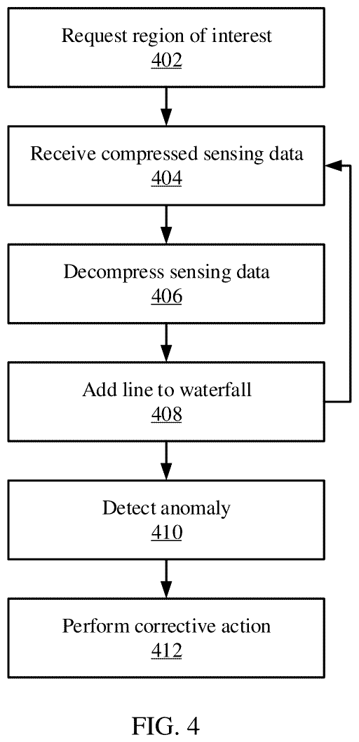

Referring now to FIG. 4, a method of assembling and using distributed fiber optic sensing information is shown. Block 402 requests a region of interest, for example transmitting to a server a set of coordinates specifying a particular length along a fiber 102. Block 404 then receives compressed sensing data from the server, which may encode a single line of sensing data taken from the region of interest. Block 406 decompresses the sensing data to generate an uncompressed line of waterfall data. Block 408 adds this new line to any previously received lines on a display, thus updating the waterfall to reflect the most recently acquired data. If the size of the waterfall with the new line exceeds the size of a display at the client, then an oldest line of the waterfall may be discarded and all remaining lines may be moved up to make room for the new line. This process may repeat for each new line of sensing data.

At some point, block 410 may detect an anomaly based on the sensing data. This detection may be performed by a human operator or may be performed automatically, for example by identifying a change in the sensing data as compared to previously received sensing data. Block 412 then performs a corrective action to address the anomaly. Exemplary corrective actions may include, for example, checking the physical condition of the fiber 102, adjusting an environmental parameter at a location of the anomaly (e.g., temperature), starting or stopping a machine in the vicinity of the anomaly, or changing a parameter of operation of such a machine.

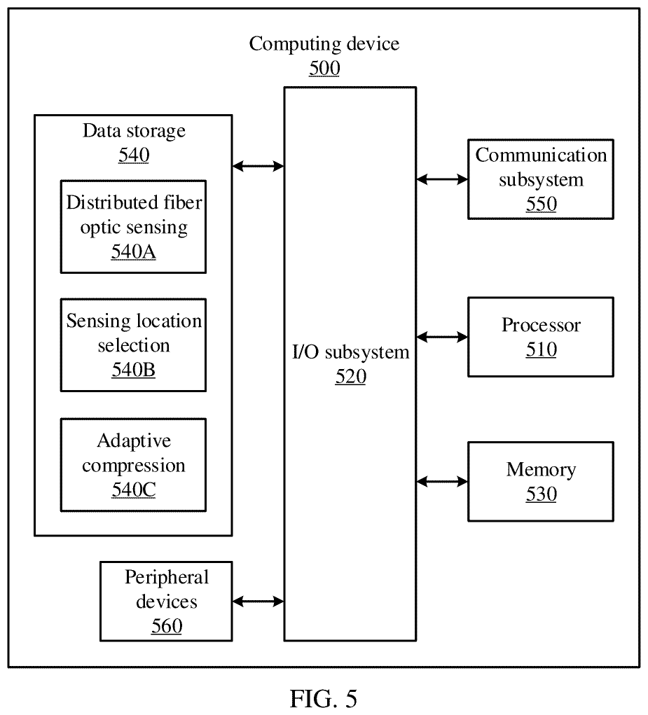

Referring now to FIG. 5, an exemplary computing device 500 is shown, in accordance with an embodiment of the present invention. The computing device 500 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 500 may be embodied as one or more compute sleds, memory sleds, or other racks, sleds, computing chassis, or other components of a physically disaggregated computing device.

As shown in FIG. 5, the computing device 500 illustratively includes the processor 510, an input/output subsystem 520, a memory 530, a data storage device 540, and a communication subsystem 550, and/or other components and devices commonly found in a server or similar computing device. The computing device 500 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 530, or portions thereof, may be incorporated in the processor 510 in some embodiments.

The processor 510 may be embodied as any type of processor capable of performing the functions described herein. The processor 510 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 530 may be embodied as any type of volatile or non-volatile memory or data storage capable of performing the functions described herein. In operation, the memory 530 may store various data and software used during operation of the computing device 500, such as operating systems, applications, programs, libraries, and drivers. The memory 530 is communicatively coupled to the processor 510 via the I/O subsystem 520, which may be embodied as circuitry and/or components to facilitate input/output operations with the processor 510, the memory 530, and other components of the computing device 500. For example, the I/O subsystem 520 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 520 may form a portion of a system-on-a-chip (SOC) and be incorporated, along with the processor 510, the memory 530, and other components of the computing device 500, on a single integrated circuit chip.

The data storage device 540 may be embodied as any type of device or devices configured for short-term or long-term storage of data such as, for example, memory devices and circuits, memory cards, hard disk drives, solid state drives, or other data storage devices. The data storage device 540 can store program code 540A for distributed fiber optic sensing, 540B for selecting sensing locations, and/or 540C for adaptive compression. Any or all of these program code blocks may be included in a given computing system. The communication subsystem 550 of the computing device 500 may be embodied as any network interface controller or other communication circuit, device, or collection thereof, capable of enabling communications between the computing device 500 and other remote devices over a network. The communication subsystem 550 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 500 may also include one or more peripheral devices 560. The peripheral devices 560 may include any number of additional input/output devices, interface devices, and/or other peripheral devices. For example, in some embodiments, the peripheral devices 560 may include a display, touch screen, graphics circuitry, keyboard, mouse, speaker system, microphone, network interface, and/or other input/output devices, interface devices, and/or peripheral devices.

Of course, the computing device 500 may also include other elements (not shown), as readily contemplated by one of skill in the art, as well as omit certain elements. For example, various other sensors, input devices, and/or output devices can be included in computing device 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 500 are readily contemplated by one of ordinary skill in the art given the teachings of the present invention provided herein.

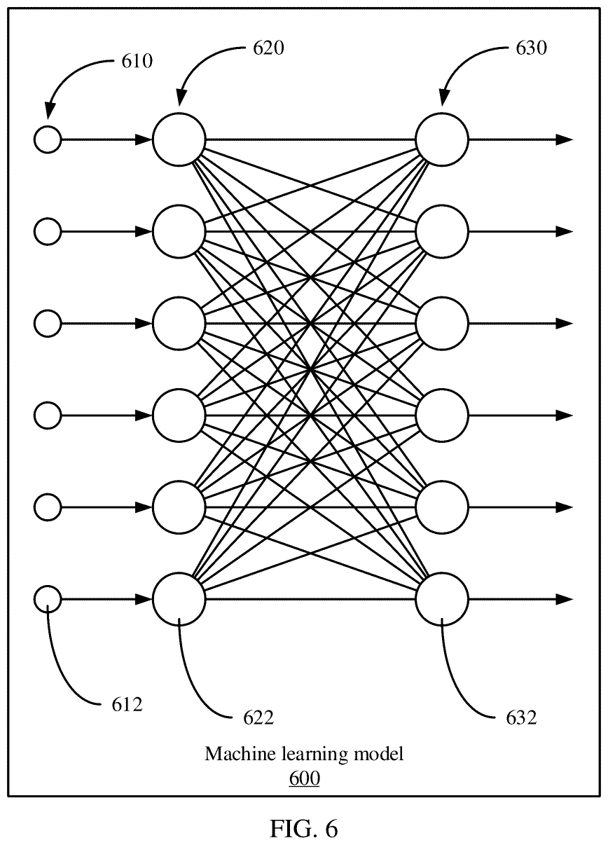

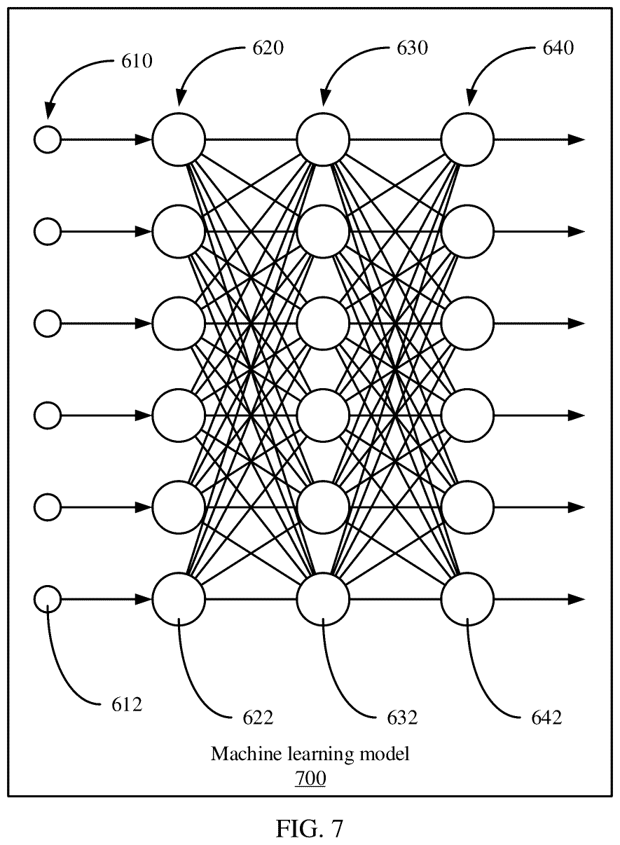

Referring now to FIGS. 6 and 7, exemplary neural network architectures are shown, which may be used to implement parts of the present models, such as the dynamic segmentation model 600/700. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 620 of source nodes 622, and a single computation layer 630 having one or more computation nodes 632 that also act as output nodes, where there is a single computation node 632 for each possible category into which the input example could be classified. An input layer 620 can have a number of source nodes 622 equal to the number of data values 612 in the input data 610. The data values 612 in the input data 610 can be represented as a column vector. Each computation node 632 in the computation layer 630 generates a linear combination of weighted values from the input data 610 fed into input nodes 620, and applies a non-linear activation function that is differentiable to the sum. The exemplary simple neural network can perform classification on linearly separable examples (e.g., patterns).

A deep neural network, such as a multilayer perceptron, can have an input layer 620 of source nodes 622, one or more computation layer(s) 630 having one or more computation nodes 632, and an output layer 640, where there is a single output node 642 for each possible category into which the input example could be classified. An input layer 620 can have a number of source nodes 622 equal to the number of data values 612 in the input data 610. The computation nodes 632 in the computation layer(s) 630 can also be referred to as hidden layers, because they are between the source nodes 622 and output node(s) 642 and are not directly observed. Each node 632, 642 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 632 in the one or more computation (hidden) layer(s) 630 perform a nonlinear transformation on the input data 612 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for sensing, comprising:
selecting a plurality of sensing locations along an optical fiber;
measuring reflections from an optical pulse on the optical fiber to generate a line of raw sensing data;
compressing the line of raw sensing data in accordance with present network conditions to generate compressed sensing data; and
transmitting the compressed sensing data to a client.

2. The method of claim 1, wherein selecting the plurality of sensing locations includes selecting a number of sensing locations based on the network conditions.

3. The method of claim 2, wherein selecting the number of sensing locations includes dividing an expected maximum data rate by an expected per-location data rate.

4. The method of claim 1, wherein selecting the plurality of sensing conditions includes selecting locations within a region of interest along the optical fiber.

5. The method of claim 4, wherein the region of interest is requested by the client.

6. The method of claim 4, wherein the region of interest is automatically selected responsive to a detected event along the optical fiber.

7. The method of claim 1, wherein compressing the line of raw sensing data includes applying a less lossy compression format to a region of interest and applying a more lossy compression format to other regions of the line of raw sensing data.

8. The method of claim 1, wherein compressing the line of raw sensing data is performed using GPU-accelerated JPEG compression.

9. The method of claim 1, wherein measuring the reflections includes measuring a time from emission of the optical pulse until reception of the reflections to determine intensity measurements at the plurality of sensing locations.

10. The method of claim 1, further comprising transmitting the optical pulse on the optical fiber and repeating the transmitting and measuring to generate successive lines of raw sensing data.

11. A system for sensing, comprising:
a hardware processor; and
a memory that stores a computer program which, when executed by the hardware processor, causes the hardware processor to:
select a plurality of sensing locations along an optical fiber;
measure reflections from an optical pulse on the optical fiber to generate a line of raw sensing data;
compress the line of raw sensing data in accordance with present network conditions to generate compressed sensing data; and
transmit the compressed sensing data to a client.

12. The system of claim 11, wherein selection of the plurality of sensing locations includes selection of a number of sensing locations based on the network conditions.

13. The system of claim 12, wherein selection of the number of sensing locations includes division of an expected maximum data rate by an expected per-location data rate.

14. The system of claim 11, wherein selection of the plurality of sensing conditions includes selection of locations within a region of interest along the optical fiber.

15. The system of claim 14, wherein the region of interest is requested by the client.

16. The system of claim 14, wherein the region of interest is automatically selected responsive to a detected event along the optical fiber.

17. The system of claim 11, wherein compression of the line of raw sensing data includes a less lossy compression format in a region of interest and a more lossy compression format in other regions of the line of raw sensing data.

18. The system of claim 11, wherein compression of the line of raw sensing data is performed using GPU-accelerated JPEG compression.

19. The system of claim 11, wherein measurement of the reflections includes measurement of a time from emission of the optical pulse until reception of the reflections to determine intensity measurements at the plurality of sensing locations.

20. A distributed fiber optic sensing system, comprising:
an optical fiber;
a light source;
a detector;
a hardware processor; and
a memory that stores a computer program which, when executed by the hardware processor, causes the hardware processor to:
select a plurality of sensing locations along the optical fiber;
transmit an optical pulse on the optical fiber using the light source;
measure reflections from an optical pulse on the optical fiber using the detector to generate a line of raw sensing data;
compress the line of raw sensing data in accordance with present network conditions to generate compressed sensing data; and
transmit the compressed sensing data to a client.
